(19) United States
(12) Patent Application Publication
(10) Pub. No.: US 2003/0031264 A1
(43) Pub. Date: Feb. 13, 2003

(54) System and method for adaptive channel diagonalization for array-to-array wireless communications

(76) Inventors: John R. Barry, Atlanta, GA (US); Joon Hyun Sung, Atlanta, GA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 09/924,128

(22) Filed: Aug. 7, 2001

(51) Int. Cl. H04L 27/00; H04B 15/00

(52) U.S. Cl. 375/259; 375/285

(57) ABSTRACT

A communication system including a unitary matrix filter and a processor configured with logic to adapt the unitary matrix filter at a receiver.

### TECHNICAL FIELD

The present invention is generally related to the field of communications, and, more particularly, to wireless communications.

### BACKGROUND OF THE INVENTION

The wireless communications field has undergone explosive growth in recent years. Much of this growth can be explained by the flexibility, or rather, the freedom to each individual user wireless communications provide. Wireless users are transacting business from their cars, keeping abreast of business from vacation spots thousands of miles away, and, more importantly, providing an important service to those in need at accident sites and other emergencies.

Wireless communications generally employ one or more antennas for radiating and receiving electromagnetic waves. Individual users may communicate directly, or via one or more intermediaries, such as radio repeaters, base stations, or switches. These intermediaries may be located on Earth (i.e. terrestrial), or may be satellite borne. A unique property that terrestrial and satellite communication systems share are the airwaves, broken down into frequency bands and space.

A natural result of sharing airwaves is the potential for interference among sending and receiving signals, which, among other things, reduces the bit rate and subsequent performance of communication systems. Thus, a heretofore unaddressed need exists in the industry for a communications system that improves the performance of communication systems.

### SUMMARY OF THE INVENTION

The preferred embodiments of the invention provide, among other things, an adaptive communications system. The adaptive communications system can generally be described as including a unitary matrix filter and a processor configured with logic to adapt the unitary matrix filter to diagonalize a transmission channel.

The preferred embodiments of the invention can also be viewed as, among other things, an adaptive communications method. This method, described generally, includes the steps of receiving a signal and adapting a unitary matrix for filtering the received signal.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a block diagram illustrating an example array to array communication system, in accordance with one embodiment of the invention.

FIG. 2A is a block diagram view of an example discrete time model for the example array-to-array system of FIG. 1, in accordance with one embodiment of the invention.

FIG. 2B is a block diagram view of an example diagonalized system matrix, in accordance with one embodiment of the invention.

FIG. 3 is a block diagram view of the example array-to-array system of FIG. 1 diagonalized using singular value decomposition, in accordance with one embodiment of the invention.

FIG. 4 is a block diagram view of the diagonalized system of FIG. 3, simplified by the lack of cross-talk between subchannels, in accordance with one embodiment of the invention.

FIG. 5 is a block diagram illustration of an example time-division duplex array-to-array wireless link, wherein unitary matrices are adapted using the adaptive SVD logic, in accordance with one embodiment of the invention.

FIG. 6 is a block diagram illustration of the system described in FIG. 5, with components combined in communication devices, in accordance with one embodiment of the invention.

FIG. 7 is a block diagram view of an example transceiver, in accordance with one embodiment of the invention.

FIG. 8A is a block diagram view of select portions of the transceiver of FIG. 7, illustrating the adaptive SVD logic incorporated in a digital signal processor (DSP), in accordance with one embodiment of the invention.

FIG. 8B is a block diagram view of select portions of the transceiver of FIG. 7, illustrating the adaptive SVD logic incorporated in memory, in accordance with one embodiment of the invention.

### DETAILED DESCRIPTION OF THE PREFERRED EMBODIMENTS

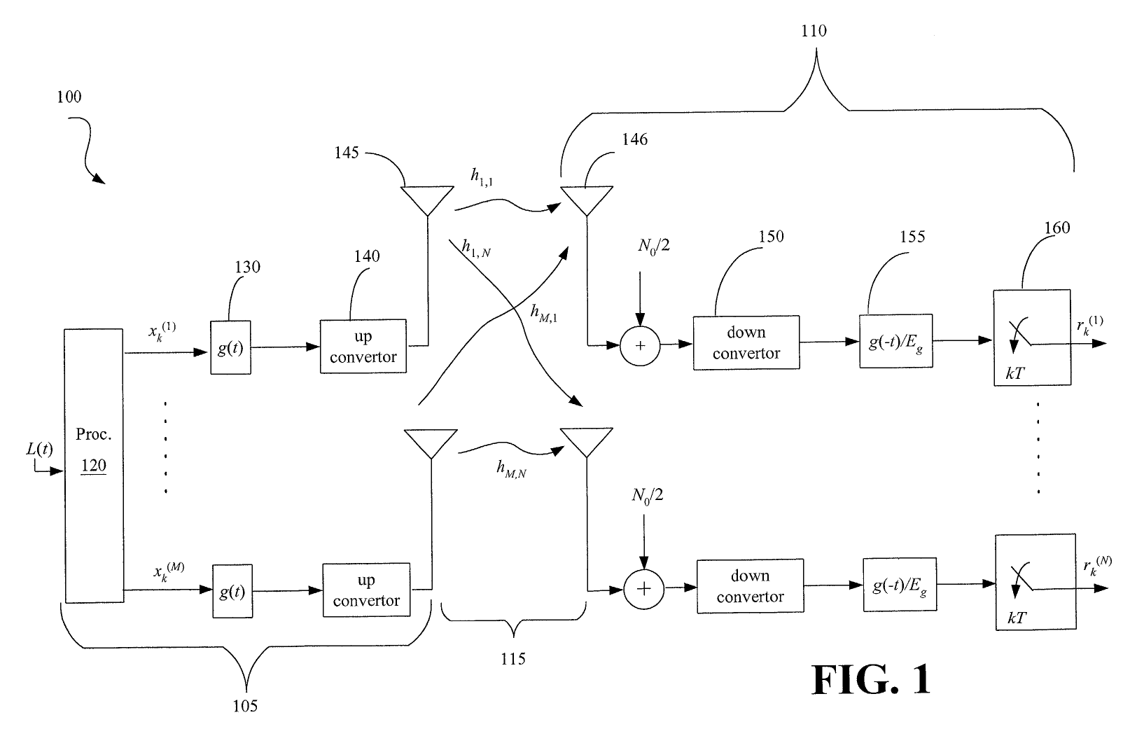

The preferred embodiments of the invention provide, among other things, a system and method for adaptive channel diagonalization for array-to-array wireless communication systems. This system and method will now be described more fully hereinafter with reference to FIGS. 1-6, in which preferred embodiments of the invention are shown. The invention can, however, be embodied in many different forms and should not be construed as limited to the embodiments set forth herein; rather, these embodiments are provided so that this disclosure will be thorough and complete, and will fully convey the scope of the invention to those skilled in the art. Furthermore, all “examples” given herein are intended to be non-limiting and among others.

FIG. 1 is a block diagram of an example array-to-array communication system 100, in accordance with one embodiment of the invention. Although described in the context of an array-to-array communication system 100, the preferred embodiments of the invention apply to systems with practically any amount of antennas at each end of the system. Further, although illustrated as a single communication system 100, it will be understood by one of ordinary skill in the art that a plurality of these systems can tie together a plurality of regional networks into an integrated global network so that system users can send and receive signals from anywhere in the world. The array-to-array system 100, in the general form illustrated in FIG. 1, comprises a transmitting system 105, a transmission medium 115, and a receiving system 110. The transmitting system 105 can be embodied in, among other things, a communication device such as a transmitter, a transceiver, a cellular base station, or a cell phone, among other devices. An input signal L(t) is input to the transmitting system processing unit 120, which can include software and/or hardware circuitry such as input/output interfaces, a microprocessor and/or a digital signal processor, memory, and programming logic to provide signal processing functions such as sampling, encoding, and other processing functions as is well known to those of ordinary skill in the art. Although illustrated as the initial interface for an input signal, L(t), some of the functions and software and/or hardware circuitry embodied in the processing unit can be located out of the illustrated sequence of transmitting system components. Further, the functions of processing unit 120 can be implemented in discrete components within or external to the transmitting system 105.

Sampling and encoding circuitry in processing unit 120 samples the received input signal L(t) and maps the sampled bit sequences into a vector sequence of symbols, xₖ. Let xₖ⁽ⁱ⁾ denote the complex quadrature amplitude modulation (QAM) symbol transmitted by the i-th antenna during the k-th signaling interval T. Alternatively, other modulation methods can be employed, including but not limited to quadrature phase shift keying (QPSK), M-ary phase shift keying (PSK), offset-QPSK, and cross-QAM. The M symbol sequences xₖ^{(l)} through xₖ^{(M)} drive identical, or substantially identical, pulse-shape filters g(t), such as filter g(t) 130. The resultant shaped signals are then upconverted by upconverters, such as upconverter 140, to a carrier frequency f₀ and transmitted across transmission medium 115 using transmitting antennas, such as transmitting antenna 145. Accordingly, the signal emitted by the i-th transmitting antenna can be represented by the equation:

Re{e^{J2πf}_{⁰}^{t}Σₖxₖ^{(t)}g(t−kT)}.

The transmitted signal represents the current (or equivalently the voltage) passing through the antenna.

In one implementation, transmission medium 115 includes a quasi-static fading channel, here represented as a matrix, H. When the transmitted signals are represented by row vectors, H can be described as an M×N matrix, where M equals the number of transmit antennas and N equals the number of receive antennas. Herein, reference to a channel will be understood to mean an M×N matrix, H, of channel coefficients, according to well-known conventions understood to those of ordinary skill in the art. Note that interference in the transmission medium 115, such as co-channel interference in a multi-user setting, is represented by the diagonal arrows from transmitting system 105 to the receiving system 110.

In this example, the signals, or symbols xₖ, are transmitted across transmission medium 115 according to one of several communication formats, including time-division duplex, frequency division multiplexing, and space multiplexing, among others. The transmitted signals, or symbols, are received at the receiving system 110 using an array of antennas, such as antenna 146. Receiving system can be embodied in a receiver, a transceiver, a cell phone, or a base station, among other devices. Although the preferred embodiment is illustrated using an antenna diversity scheme of multiple antennas on the receiving and transmitting end, systems including practically any quantity of antennas at the transmitting and receiving end can be employed while still maintaining the scope of the preferred embodiments of the invention.

Let N be the number of receiver antennas. At the receiving system 110, N passband observations are downconverted at downconverters such as downconverter 150, filtered by a filter such as filter g(−t) 155, and sampled at the symbol rate at samplers such as sampler 160 to produce N received sequences rₖ^{(l)} through rₖ^{(N)}. Note that filtering, downconverting, and sampling can be performed in separate, discrete components, or integrated components, in hardware, software, or a combination of both, at the receiving system 110, or at one or more components located external to the receiving system. When the frequency response hᵢⱼ (f) from antenna i to antennaj does not differ appreciably from hᵢⱼ=hᵢⱼ (f₀) over the signal band, the equivalent discrete-time model can be mathematically represented as follows:

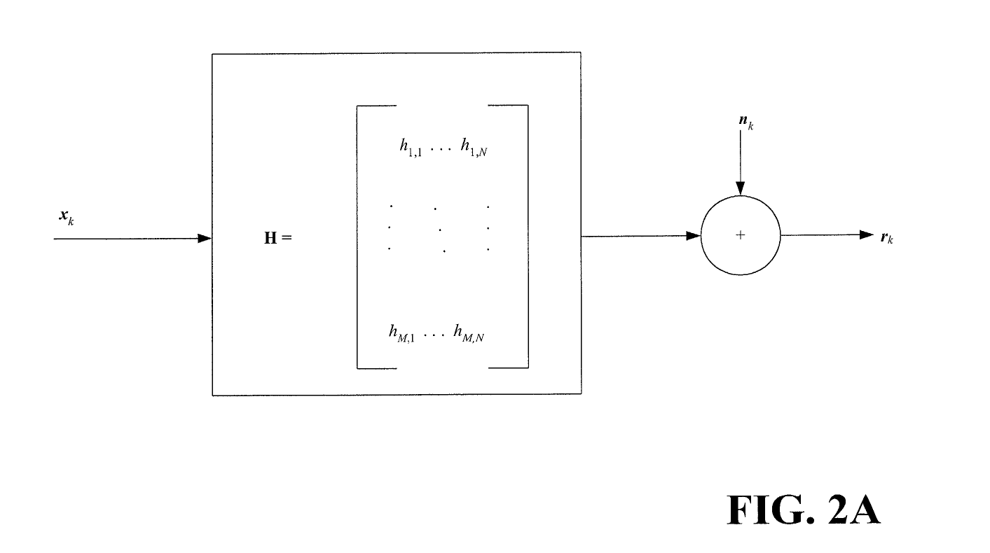

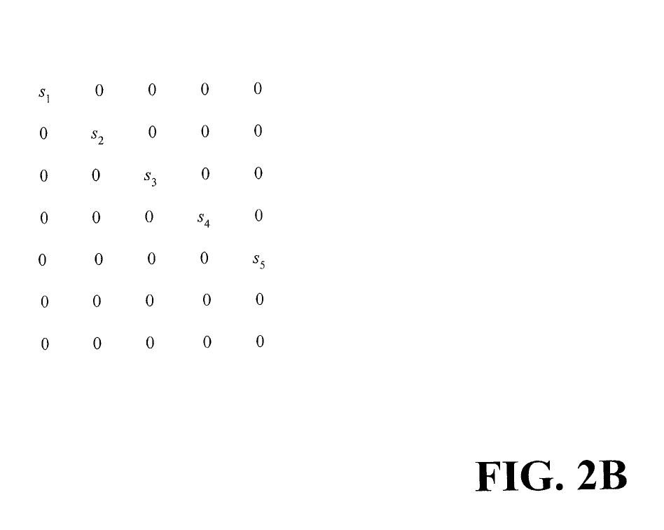

rₖ=xₖH+nₖ

where xₖ=[xₖ^{(l)}, . . . , xₖ^{(M)}] and rₖ=[rₖ^{(l)}, . . . , rₖ^{(N)}] are row vectors, and nₖ represents white Gaussian noise, as is well known to those of ordinary skill in the art. This discrete time model is illustrated in FIG. 2A. As noted in FIG. 2A, the channel matrix H is an M×N matrix that can be decomposed according to one of several methods. In the preferred embodiment, the channel matrix H is decomposed into three matrices by using singular value decomposition (SVD). It is well known to those of ordinary skill in the art that a theoretically optimal form of space time coding for array-to-array wireless links is based on a singular-value decomposition (SVD) of the channel matrix (H=USV*), where V* is the Hermitian transpose of V. However, there have been at least two practical obstacles to an SVD based space-time code. First, the transmitter must know something about the channel, and second, the transmitter must be capable of adapting a unitary matrix. A direct implementation involving channel estimation via feedback followed by a numerical SVD computation would be both high in complexity and susceptible to time-varying channels. As described below, the preferred embodiments of the invention provide adaptive diagonalization of the channel matrix H via an adaptive SVD method and system and reciprocity in a communication system. With SVD, every M×N matrix can be expressed as H=USV*, where U (M×M) and V (N×N) are both unitary and complex valued. The eigenvalues of a unitary matrix all have an absolute value of one (1), and the determinant of a unitary matrix has an absolute value of one (1). S (M×N) is real, non-negative, and diagonal with its diagonal element arranged in non-increasing order. That is, if sᵢⱼ denotes the element of S that is in row i and column j, then sᵢⱼ=0 if i differs from j, and s_{1,1}≧s_{2,2}≧s_{3,3}, etc. The diagonal elements of S are the singular values of H. For example, with seven (7) transmit antennas and five (5) receive antennas, S would look like the matrix illustrated in FIG. 2B, with the property that s₁≧s₂≧s₃≧s₄≧s₅.

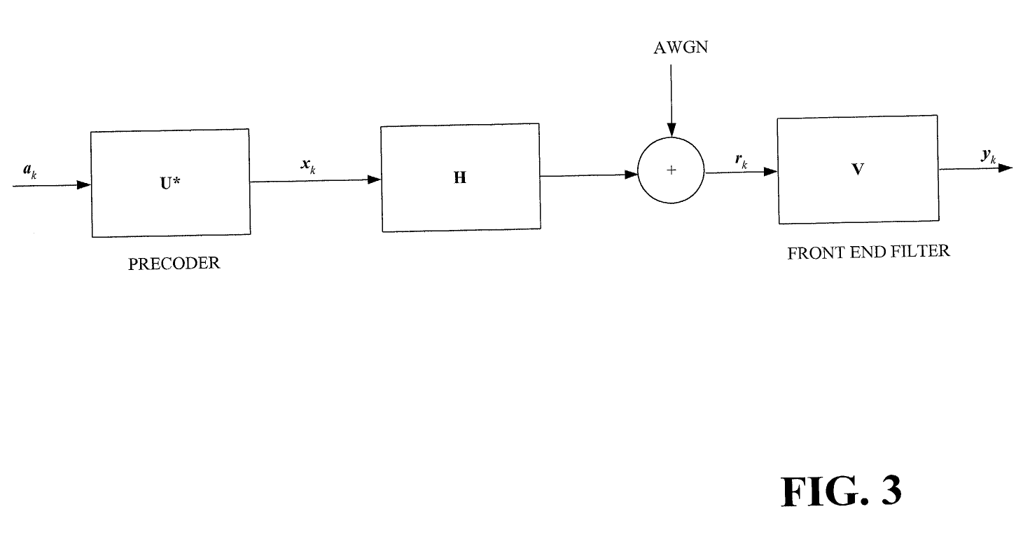

One of the goals in communication systems is to maximize the bit rate. But Shannon theory explains that, in order to maximize the bit rate, the channel has to be diagonalized using signal processing based on a SVD of the channel matrix. An added benefit of diagonalizing the channel is that it reduces the complexity. If the channel were not diagonal, then complications can occur since the signals being transmitted at the different antennas may need to be coordinated. A further complication is that the signals received at different receiver system antennas may have to be processed jointly. To diagonalize a channel, or channel matrix, a capacity achieving transmitter will first process the transmitted signals by a unitary precoder filter U*, as shown in FIG. 3. Without SVD at the transmitting system, the transmitting system may send information simultaneously from all transmitting system antennas (i.e. equivalent to using a “precoder” that is a constant row vector). Another possible consideration of not using SVD at the transmitting system is that some form of space-time block coding may need to be used, such as the Almouti method, as is well known to those of ordinary skill in the art. Both of these latter considerations may result in a smaller bit rate.

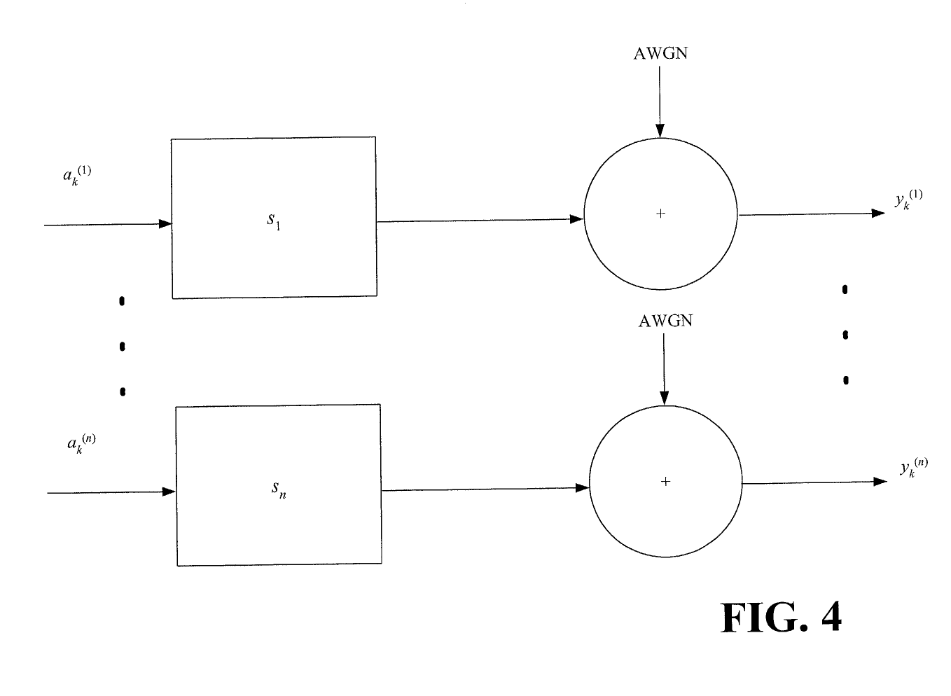

In a preferred embodiment, a capacity-achieving transmitting system 105 preprocesses the transmitted symbols with the unitary precoder filter U* (i.e. filter at the transmitting system), and the receiving system 110 uses a unitary front-end filter V (i.e. a filter at the receiving system) such that the overall system is diagonal: S=U*HV. This overall system is illustrated in FIG. 3. Unitary precoder filter U* can be implemented using software and/or hardware, as can unitary front-end filter V. Noise, represented by vector nₖ, is introduced into the system, but in preferred implementations, is Gaussian and white (i.e. its components are considered independent). The effect of the independent nature of the noise is that the noise after diagonalization has the same statistics as the noise before diagonalization. With diagonalization, the system of FIG. 3 can be broken down, or modeled, as a collection of n scalar channel systems (subchannels) as illustrated in FIG. 4. The number of subchannels n in FIG. 4 will be equal to the number of transmit antennas M, or the number of receive antennas N, whichever is smaller (if M=N, then n=M=N). With a diagonal channel, the different subchannels illustrated in FIG. 4 are independent in the sense that they do not interact with each other. One result of this independence is that the subchannels can be processed independently as a collection of unrelated scalar channels. The overall system can thus be modeled as a system where communication occurs across a bank of n independent parallel additive white Gaussian noise (AWGN) channels. There are well-known “water-pouring” strategies for allocating power and bits to each of the channels in accordance with their SNR so as to maximize throughput.

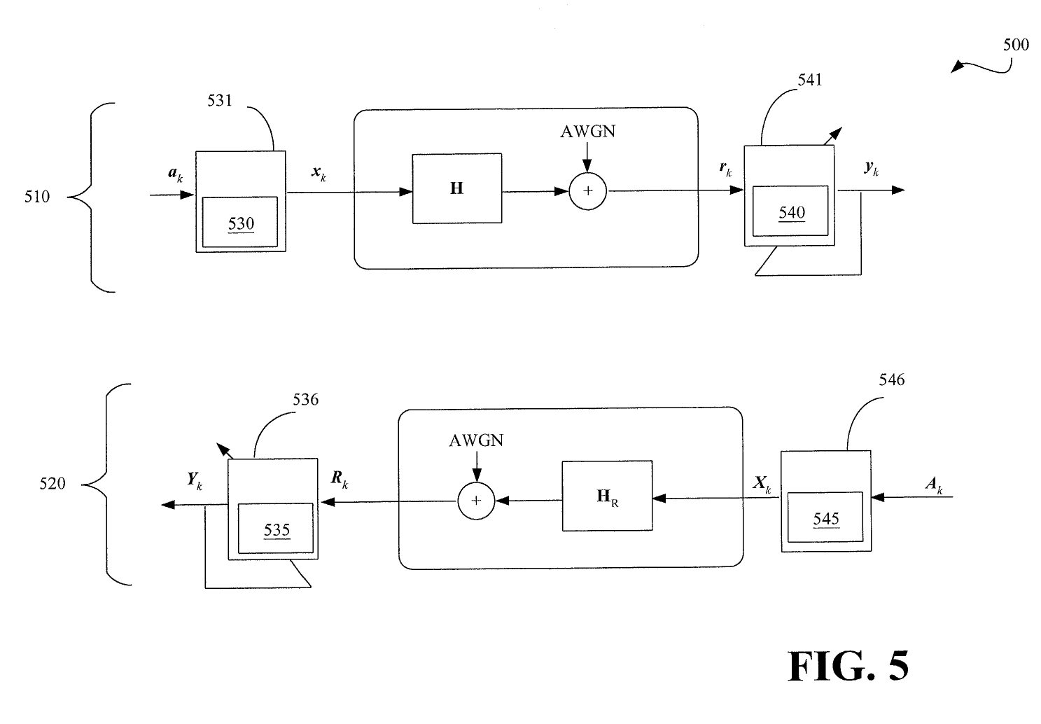

The preferred space-time coding strategy in array-to-array communications depends strongly on whether or not the transmitting system 105 knows the channel H. In particular, a transmitting system 105 with knowledge of H preferably exploits this channel knowledge in order to approach the theoretical Shannon capacity (i.e. the fundamental upper limit on achievable bit rates with minimal bit errors). The use of SVD space-time processing in a time-division duplex (TDD) array-to-array wireless link (or system) 500 is illustrated in FIG. 5, according to one implementation. FIG. 5 is intended to illustrate, among other things, a conceptual basis of how a signal is processed in the TDD system of the preferred embodiment. Although described in relation to a TDD array-to-array link 500, other multiplexing systems such as, for example, frequency-division multiplexing, and space multiplexing, can be considered within the scope of the embodiments of the invention. A TDD communication format preferably operates using a single frequency band to transmit signals alternately in the forward direction (i.e. transmitter to receiver) and then the reverse direction (i.e. receiver to transmitter). Thus, a communication device in a TDD system preferably alternates between operating as a transmitter and a receiver. TDD can operate using the same frequency by allocating distinct time slots to the forward and reverse directions. In particular, time is divided into frames which are divided in slots of short duration. In TDD, the relative capacity of the forward and reverse directions can be adjusted to provide for the greater carrying capacity direction. This adjustment is preferably accomplished by providing a greater time allocation to forward transmission intervals than reverse transmission (via allocating more time slots for the forward direction).

The upper half of the figure depicts the forward link 510, with matrix transfer function H, and the lower half of the figure depicts the reverse link 520, with transfer function H_{R}. For notational convenience, the forward signals (i.e. symbol vectors, denoted in lower case) are represented as row vectors, while the reverse signals (denoted in upper case) are represented as column vectors, so that:

rₖ=xₖH+nₖ

Rₖ=H_{R}Xₖ+Nₖ

In a preferred embodiment, reciprocity holds and the channel changes slowly, such that the reverse and forward channels are identical (i.e. H_{R}=H). Assume the forward link 510 and the reverse link 520 are separate communication links. The forward link connects transmitter 531 (including unitary precoder filter 530) with receiver 541 (including unitary front end filter 540). Reverse link 520 connects transmitter 546 (including unitary precoder filter 545) to receiver 536 (including unitary front end filter 535). Unitary precoder filters 530 and 545 and unitary front-end filters 540 and 535 can be implemented with hardware, or a combination of hardware and software, but preferably are implemented in software. Unitary precoder filters 530 and 545 and unitary front-end filters 540 and 535 are filters that are adapted to accommodate the unknown channel. Unitary precoder filter 530 and unitary front-end filter 535 preferably closely match the true U* defined by the SVD of H. Similarly, unitary front-end filter 540 and unitary precoder 545 preferably closely match the true V defined by the SVD of H.

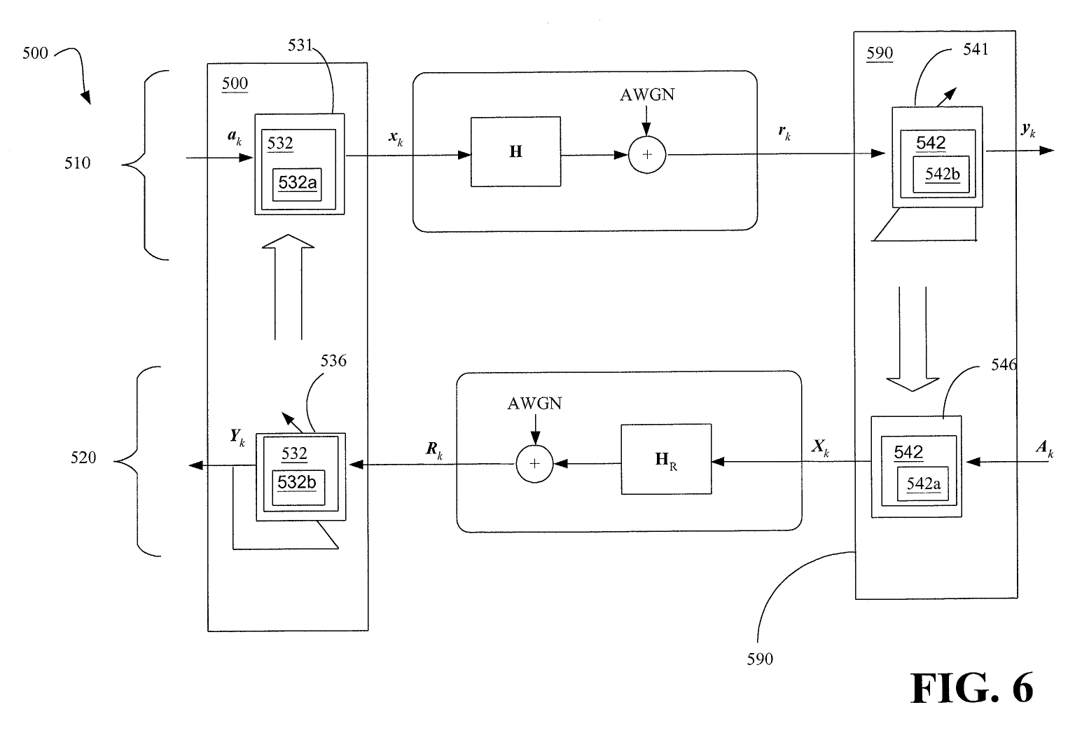

FIG. 6 is a block diagram illustration resulting from placing transmitter 531 and receiver 536 in the same communication device 500, and placing transmitter 546 and receiver 541 in the same communication device 590, for the TDD array-to-array system 500. Communication devices 500 can include a transceiver, such as a modem or a cell phone, among other devices. FIG. 6 is intended to illustrate, among other things, an embodiment where the functions of the unitary precoder filter 545 are embodied in the same filter as the functions of unitary front-end filter 540. Thus, unitary filter 542 is comprised of unitary precoder functionality 542a and unitary front-end filter functionality 542b. Similarly, in this embodiment, unitary filter 532 is comprised of unitary precoder functionality 532a (corresponding to unitary precoder filter 530) and unitary front-end filter functionality 532b (corresponding to unitary and front-end filter 535. Thus, in a preferred embodiment, there exists a single unitary filter for each communications device (e.g. 500 or 590) that effectively performs two roles, one as a unitary precoder filter and another as a unitary front-end filter. Unitary filters 532 and 542 (and sub-component functionality) can be implemented in hardware, or a combination of hardware and software, but are preferably implemented in software. During forward transmission, transmitter 531 transmits and receiver 541 “listens.” The receiver 541 “listens” in order to, among other things, learn something about the channel H. For example, in the context of mobile phone use, as the transmitter 531 moves, or the receiver moves 541, or a vehicle drives by, the channel matrix H will change. The receiver 541 observes rₖ. The receiver 541, in one implementation, can learn H from rₖ, but a preferred embodiment of the invention simplifies this learning process. In a preferred implementation, the receiver 541 only needs to learn the V of the SVD H=USV*, not all of H. Each time a packet of information is transmitted, the receiver 541, via SVD adaptive logic 710, described below, “adapts” or “adjusts” its estimate of V. As described above, in a preferred implementation, the receiver 541 does not learn about all of H, but only one of the unitary factors in a SVD of the channel H. Note that unitary factors herein refer to the unitary SVD factors U and V* and V.

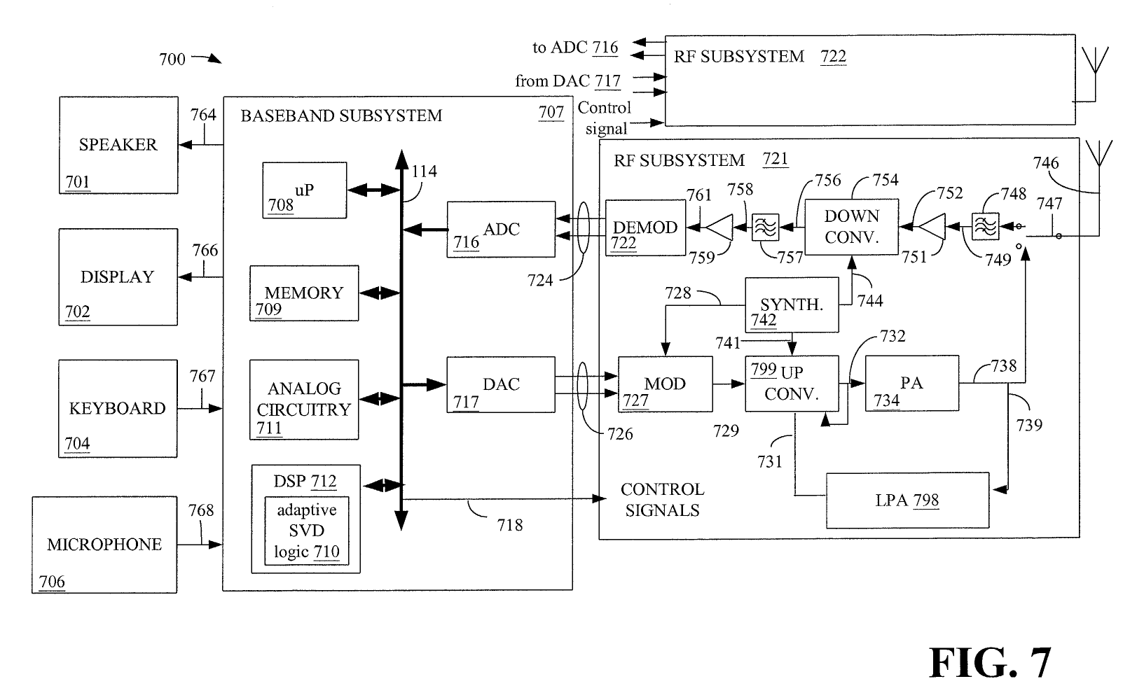

One benefit of not needing to know all about H is that the receiver 541 may adapt its unitary front-end filter functionality 542b blindly, without requiring a training signal. For example, in a conventional SVD-based link, a transmitter needs to know something about the channel, and a receiver is where the channel knowledge occurs. Thus, in such conventional systems, the receiver learns the channel, then provides feedback of this information to the transmitter. One end of the link or the other end then performs an explicit SVD computation. Usually, the receiver can learn the channel only when it knows what the transmitted signal is, in which case, this signal conveys no useful information, but instead is a so-called “training sequence” that was agreed on beforehand. Both feedback and training typically reduce the usable data rate. In a preferred embodiment of the invention, no feedback and no training is required. A preferred embodiment of the invention exploits reciprocity in a TDD system, and the fact that only “half” the channel needs to be known at each end at any one time (i.e. neither end of the link needs to know the entire channel H). For example, the desired unitary front-end filter functionality 542 is fully determined by the eigenvectors of the sample autocorrelation matrix of the received vector sequence, which can be computed blindly and with low complexity using well-known subspace tracking algorithms. By using subspace tracking, an explicit computation of the SVD can be avoided. While receiver 541 is “learning” about the V term in the channel SVD H=USV* (i.e. not a full-blown estimation of H), transmitter 546 and receiver 536 sit idle. Adaptive SVD logic 710 (FIG. 7), described below, in receiver 541 adapts (i.e. adjusts) unitary front-end filter functionality 542 to accommodate an unknown and/or time-varying channel. Unitary front-end filter functionality 542 includes, in one implementation, a collection of N² gains and adders (implemented in hardware, or a combination of both hardware and software, or preferably software, as discussed above), where each output is a linear combination of the N inputs. These gains are adjusted (or adapted) according to an algorithm within the adaptive SVD logic 710. One such algorithm can include the process of estimating H, then performing an explicit internal SVD yielding H=USV*. Then the adaptive SVD logic 710 can choose the gains in order to implement V. Another algorithm, of lesser complexity and greater efficiency, can include the algorithm described above, in which the adaptive SVD logic 710 accepts the receive vectors, rₖ, and forms the sample autocorrelation matrix B. Then the eigenvectors of B are the columns of the desired V matrix. Other subspace tracking algorithms can be used, with less computational complexity. Thus, in a software implementation, adaptive SVD logic 710 can determine what the unitary filter should be, and then implement that filter.

When transmitter 531 has completed transmission, the reverse transmission (via reverse link 520) begins. Now, transmitter 546 transmits and receiver 536 “listens” while transmitter 531 and receiver 541 sit idle. When transmitter 546 transmits, it uses as a unitary precoder filter the same unitary matrix that receiver 541 used as a unitary front-end filter. Thus, when transmitter 531 transmits the signal to receiver 541, in the preferred embodiment, receiver 541 monitors its received signal in order to “learn” one of the unitary factors of the channel SVD H=USV*. Thus, receiver 541, or rather adaptive SVD logic 710 of receiver 541, adapts (i.e. adjusts a little bit each instant) unitary front end filter functionality 542. Consequently, the transmitter 546 acquires knowledge of what its precoder filter functionality 542a should be, without feedback from the receiver 541 telling the transmitter 546 what the channel H is, and without training, and with no explicit SVD computations (i.e. full blown SVD computations of H=USV*).

In a preferred embodiment, receivers 541 and 536 adapt (via adaptive SVD logic 710), whereas transmitters 531 and 536 receive instructions from their respective receiver counterparts (i.e. inside their respective boxes, or systems, 500 and 590). For example, whatever receiver 541 uses as a unitary front-end filter, transmitter 546 also uses (without modification) as a unitary precoder filter. Similarly, whatever receiver 536 uses as a unitary front-end filter, transmitter 531 uses (without modification) as a unitary precoder filter. Thus, in preferred embodiments, both ends of a link (forward or reverse) can implement optimal space-time processing without the need for feedback from the receiver to the transmitter, and without the need for training.

FIG. 7 is a block diagram illustrating a simplified portable transceiver 700, in accordance with one embodiment, of other embodiments, of the invention. Although shown with an array of two antennas (corresponding to two RF subsystems 721 and 722), fewer or more are within the scope of the preferred embodiments of the invention. Portable transceiver 700 includes speaker 701, display 702, keyboard 704, and microphone 706, all connected to baseband subsystem 707. In a particular embodiment, portable transceiver 700 can be, for example but not limited to, a portable telecommunication handset such as a mobile cellular-type telephone. Speaker 701 and display 702 receive signals from baseband subsystem 707 via connections 764 and 766, respectively, as known to those skilled in the art. Similarly, keyboard 704 and microphone 106 supply signals to baseband subsystem 707 via connections 767 and 768, respectively. Baseband subsystem 707 includes microprocessor (μP) 708, memory 709, analog circuitry 711, and digital signal processor (DSP) 112, with adaptive SVD logic 710, in communication via bus 714. Bus 714, although shown as a single bus, may be implemented using multiple busses connected as necessary among the subsystems within baseband subsystem 707. Microprocessor 708 and memory 709 provide the signal timing, processing, and storage functions for portable transceiver 700. Analog circuitry 711 provides the analog processing functions for the signals within baseband subsystem 707. Baseband subsystem 707 provides control signals to radio frequency (RF) subsystem 721 via connection 718. Although shown as a single connection 718, the control signals may originate from DSP 712 or from microprocessor 108, and are supplied to a variety of points within RF subsystem 721 and 722. It should be noted that, for simplicity, only the basic components of portable transceiver 700 are illustrated herein. Baseband subsystem 707 also includes analog-to-digital converter (ADC) 716 and digital-to-analog converter (DACs) 717. ADC 716 and DAC 717 also communicate with microprocessor 708, memory 709, analog circuitry 711 and DSP 712 via bus 714. DAC 717 converts the digital communication information within baseband subsystem 707 into an analog signal for transmission to RF subsystem 721 and 722 via connection 726. Connection 726, while shown as two directed arrows, includes the information that is to be transmitted by RF subsystem 721 and 722 after conversion from the digital domain to the analog domain.

RF subsystem 721 and 722 include the same, or substantially the same components, and thus the RF subsystem discussion will focus on the components shown in RF subsystem 721, with the understanding that the following discussion pertains to the RF subsystem 722 as well. RF subsystem 721 includes modulator 727, which after receiving a frequency reference signal (also called a “local oscillator” signal, or “LO”) from synthesizer 742 via connection 728, modulates the received analog information and provides a phase and amplitude modulated signal via connection 729 to upconverter 799. Upconverter 799 also receives a frequency reference signal from synthesizer 742 via connection 741. Synthesizer 742 determines the appropriate frequency to which upconverter 799 will upconvert the phase and amplitude modulated signal on connection 729.

Upconverter 799 supplies the phase and amplitude modulated signal via connection 732 to power amplifier 734. Power amplifier 734 amplifies the modulated signal on connection 732 to the appropriate power level for transmission via connection 738 to antenna 746. Illustratively, switch 747 controls whether the amplified signal on connection 738 is transferred to antenna 746 or whether a received signal from antenna 746 is supplied to filter 748. The operation of switch 747 is controlled by a control signal from baseband subsystem 707 via connection 718.

A portion of the amplified transmit signal on connection 738 is supplied via connection 739 to a linear power amplifier 798. The linear power amplifier 798 supplies a feedback signal via connection 731 to the upconverter 799. In addition, a portion of the output of the upconverter 799 is supplied via connection 732 back to the upconverter. The feedback from the upconverter 799 forms a first feedback loop and the feedback from the linear power amplifier 798 forms a second feedback loop. The two feedback loops are controlled via a pair of phase detectors and corresponding charge pumps (not shown) located in the upconverter 799. Prior to transmitting, it is desirable to lock the translation loop formed by the upconverter 799 with the input signal to the power amplifier 734 and, after transmission has begun, to lock the translation loop with a signal taken from the output of the power amplifier 734.

In the RF subsystem 721, a signal received by antenna 746 will, at the appropriate time determined by baseband system 707, be directed via switch 747 to receive filter 748. Receive filter 748 filters the received signal and supplies the filtered signal on connection 749 to low noise amplifier (LNA) 751. Receive filter 748 is a bandpass filter, which passes all channels of the particular cellular system in which the portable transceiver 700 is operating. As an example, for a 900 MHz GSM system, receive filter 748 would pass all frequencies from 935.1 MHz to 959.9 MHz, covering all 724 contiguous channels of 200 kHz each. The purpose of this filter is to reject all frequencies outside the desired region. LNA 751 amplifies the very weak signal on connection 749 to a level at which downconverter 754 can translate the signal from the transmitted frequency back to a baseband frequency. Alternatively, the functionality of LNA 751 and downconverter 754 can be accomplished using other elements, such as for example but not limited to, a low noise block downconverter (LNB).

Downconverter 754 receives a frequency reference signal (also called a “local oscillator” signal or “LO”) from synthesizer 742, via connection 744, which signal instructs the downconverter 754 as to the proper frequency to which to downconvert the signal received from LNA 751 via connection 752. The downconverted frequency is called the “intermediate frequency” or “IF”. Downconverter 754 sends the downconverted signal via connection 756 to channel filter 757, also called the “IF filter”. Channel filter 757 filters the downconverted signal and supplies it via connection 758 to amplifier 759. The channel filter 757 selects the one desired channel and rejects all others. Using the GSM system as an example, only one of the 724 contiguous channels is actually to be received. After all channels are passed by receive filter 748 and downconverted in frequency by downconverter 754, only the one desired channel will appear at the center frequency of channel filter 757. The synthesizer 742, by controlling the local oscillator frequency supplied on connection 744 to downconverter 754, determines the selected channel. Amplifier 759 amplifies the received signal and supplies the amplified signal via connection 761 to demodulator 722. Demodulator 722 recovers the transmitted analog information and supplies a signal representing this information via connection 724 to ADC 716. ADC 716 converts these analog signals to a digital signal at baseband frequency and transfers it via bus 714 to DSP 712 for further processing.

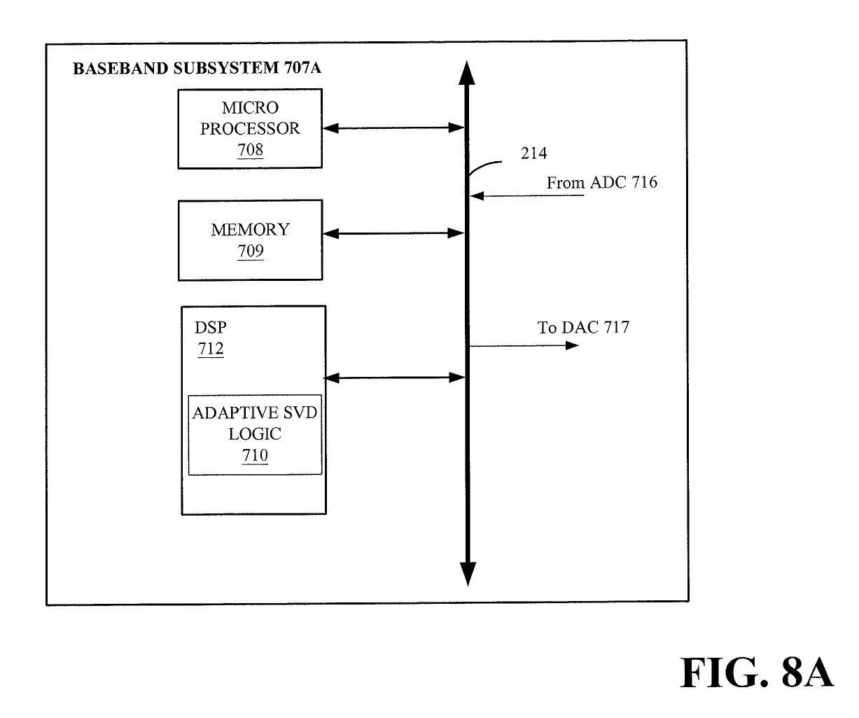

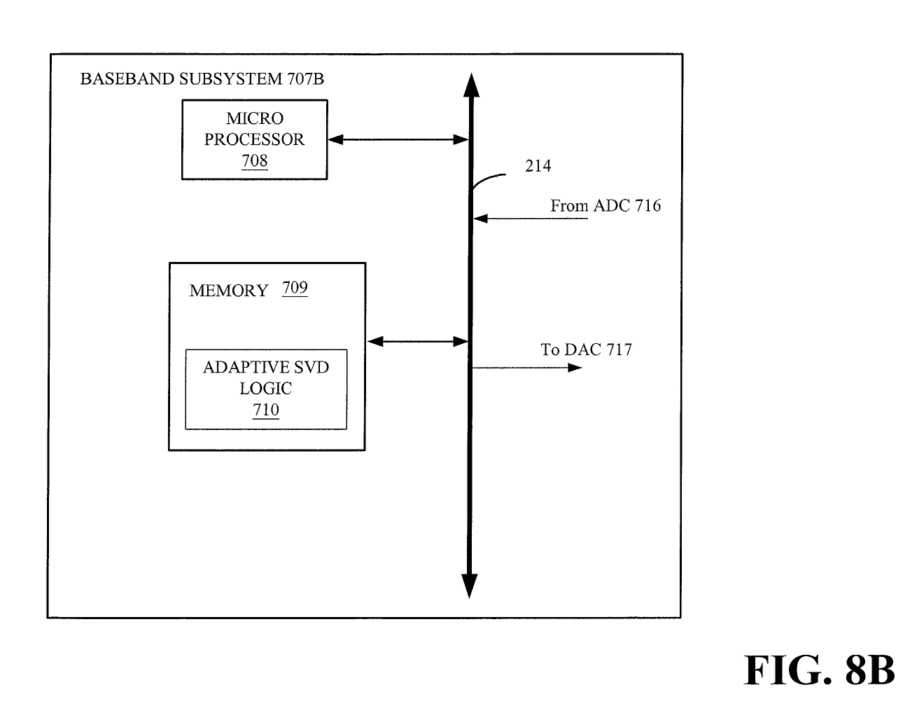

FIG. 8A-8B are a block diagram illustrations of select components of the baseband subsystem 707 of FIG. 7, in accordance with one embodiment of the invention. FIG. 8A describes one embodiment, in which the adaptive SVD logic 710 is implemented as logic structured within the DSP 712. The DSP 712 can be custom made or a commercially available DSP, running the adaptive SVD logic 710 alone or in combination with the microprocessor 718. The microprocessor 728 is a hardware device for executing software, particularly that stored in memory 730. The microprocessor 728 can be any custom made or commercially available processor, a central processing unit (CPU), an auxiliary processor among several processors associated with the adaptive SVD logic 710, a semiconductor based microprocessor (in the form of a microchip or chip set), a macroprocessor, or generally any device for executing software instructions.

FIG. 8B describes another embodiment, wherein the adaptive SVD logic 710 is embodied as programming structure in memory 709, as will be described below. The memory 730 can include any one or combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory 730 may incorporate electronic, magnetic, optical, and/or other types of storage media. Note that the memory 730 can have a distributed architecture, where various components are situated remote from one another, but can be accessed by the microprocessor 728.

In one implementation, the software in memory 730 can include adaptive SVD logic 710, which provides executable instructions for implementing the unitary matrix adaptations, as described above. The software in memory 730 may also include one or more separate programs, each of which comprises an ordered listing of executable instructions for implementing logical functions and operating system functions such as controlling the execution of other computer programs, providing scheduling, input-output control, file and data management, memory management, and communication control and related services.

When the communication system 700 is in operation, the microprocessor 728 is configured to execute software stored within the memory 730, to communicate data to and from the memory 730, and to generally control operations of the communication system 700 pursuant to the software.

When the adaptive SVD logic 710 is implemented in software, it should be noted that the adaptive SVD logic 710 can be stored on any computer readable medium for use by or in connection with any computer related system or method. In the context of this document, a computer readable medium is an electronic, magnetic, optical, or other physical device or means that can contain or store a computer program for use by or in connection with a computer related system or method. The adaptive SVD logic 710 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

In an alternative embodiment, where the adaptive SVD logic 710 is implemented in hardware, the adaptive SVD logic 710 can implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

The following is claimed:

1. An adaptive communications system comprising:
a unitary matrix filter; and
a processor configured with logic to adapt the unitary matrix filter to diagonalize a transmission channel.

2. The system of claim 1, wherein the processor is further configured with logic to adapt the unitary matrix filter at a receiver, and then use the unitary matrix filter for transmission when the receiver becomes a transmitter.

3. The system of claim 2, wherein the processor is further configured with logic to use the unitary matrix filter for transmission without feedback from the receiver to the transmitter.

4. The system of claim 1, wherein the processor is further configured with logic to represent a transmission channel as a channel matrix, wherein the processor is further configured to diagonalize the channel matrix by singular value decomposition.

5. The system of claim 1, wherein the unitary matrix filter filters symbol vectors corresponding to a communication signal.

6. The system of claim 5, wherein the symbol vectors include discrete modulated signals.

7. The system of claim 6, wherein the discrete modulated signals are transmitted and received in an array-to-array communications system.

8. The system of claim 6, wherein the discrete modulated signals are transmitted and received in an array-to-array time division duplex communications system.

9. The system of claim 1, wherein the processor and the logic and the unitary matrix filter are embodied in a receiver.

10. The system of claim 1, wherein the processor and the logic and the unitary matrix filter are embodied in a transmitter.

11. The system of claim 1, wherein the processor and the logic and the unitary matrix filter are embodied in a transceiver.

12. The system of claim 1, wherein the processor and the logic and the unitary matrix filter are embodied in a cellular phone.

13. The system of claim 1, wherein the processor and the logic and the unitary matrix filter are embodied in a base station.

14. The system of claim 1, wherein the processor and the logic and the unitary matrix filter are embodied in a modem.

15. The system of claim 1, wherein the unitary matrix filter is defined by a singular value decomposition of a channel matrix.

16. The system of claim 1, wherein the processor is further configured with the logic to adapt the unitary matrix filter without requiring a training sequence.

17. The system of claim 1, wherein the processor is further configured with the logic to adapt the unitary matrix filter without requiring feedback to a transmitter from a receiver.

18. The system of claim 1, wherein the processor is further configured with the logic to adapt an estimate of a unitary factor of a singular value decomposition of a channel matrix.

19. An adaptive communications method comprising the steps of:
receiving a signal; and
adapting a unitary matrix for filtering the received signal.

20. The method of claim 19, further comprising the step of filtering a transmitted signal with the unitary matrix.

21. The method of claim 20, wherein the step of filtering is performed without feedback about the received signal.

22. The method of claim 19, further comprising the steps of representing a transmission channel as a channel matrix and diagonalizing the channel matrix by singular value decomposition.

23. The method of claim 19, further comprising the step of representing the signal as symbol vectors corresponding to a communication signal.

24. The method of claim 23, wherein the symbol vectors include discrete modulated signals.

25. The method of claim 24, wherein the discrete modulated signals are transmitted and received in an array-to-array communications system.

26. The method of claim 25, wherein the discrete modulated signals are transmitted and received in an array-to-array time division duplex communications system.

27. The method of claim 19, further comprising the step of implementing singular value decomposition processing without feedback from a receiver to a transmitter.

28. The method of claim 19, further comprising the step of defining the unitary matrix by a singular value decomposition of a channel matrix.

29. The method of claim 19, wherein the step of adapting further includes the step of adapting the unitary matrix without requiring a training sequence.

30. The method of claim 19, wherein the step of adapting further includes the step of adapting the unitary matrix without requiring feedback to a transmitter from a receiver.

31. The method of claim 19, wherein the step of adapting further includes the step of adapting an estimate of a unitary factor of a singular value decomposition of a channel matrix.
